(19) United States
(12) Patent Application Publication
(10) Pub. No.: US 2013/0325750 A1
(43) Pub. Date: Dec. 5, 2013

(54) SYSTEM AND METHOD FOR AN ALGORITHM INVESTMENT MODEL

(71) Applicant: Massively Parallel Technologies, Inc., Boulder, CO (US)

(72) Inventor: Kevin D. Howard, Tempe, AZ (US)

(21) Appl. No.: 13/910,860

(22) Filed: Jun. 5, 2013

Related U.S. Application Data
(60) Provisional application No. 61/655,780, filed on Jun. 5, 2012.

(51) Int. Cl. G06Q 40/06

(52) U.S. Cl. CPC G06Q 40/06
USPC 705/36 R

(57) ABSTRACT

A system and method for raising funds for the development of a software application by pre-licensing a software application in a parallel processing development environment. Further including a pre-license auction aspect for auctioning off excess application uses to other users that exist within the development environment.

### RELATED APPLICATIONS

This application claims priority to U.S. Provisional Application Ser. No. 61/655,780 (hereinafter “'780 provisional”), filed 5 Jun. 2012, which is incorporated herein by reference.

### BACKGROUND

Small software developers sometimes require investment to complete a project, for example, to pay employees or contract developers to write an application. The standard investment models available to corporations are may not be appropriate for the small software developer. If, for example, the development tools utilized in the development of the software product are Cloud-Based development tools then there are no hard assists (e.g., equipment, machinery, etc.), no property (e.g., office furniture, real-estate, etc.), and no income prior to software release. Therefore, collateral may not exist to secure a loan, for example. In addition, there may exist obstacles to incorporation, such as the financial expensive of incorporation, such that raising capital through the sale of stock is not possible. Thus, one of the only possible assists is a license fee that would become available after the software is released.

If Cloud-Based software is sold as software-as-a-service, for example, then a license may be a guarantee for a given number of uses or some use during a specified time-period. If the license guarantees a given number of uses then a pre-release number of uses may also be sold. If there is a link between pre-release uses and some percent of future income then there is a basis for investment.

In addition to developers having problems raising funds, end-users have a problem with over purchasing uses.

### SUMMARY OF THE INVENTION

In one embodiment, the system provides a user the opportunity to pre-license a software application developed in a parallel processing development environment.

In an embodiment, the system offers a novel bid/ask system to allow an end-user to sell extra uses, or sell their investment.

### BRIEF DESCRIPTION OF THE FIGURES

FIG. 1 shows pre-licensing opportunities screen, in an exemplary embodiment.

FIG. 2 shows an exemplary pre-license application description screen, in an embodiment.

FIG. 3 shows an exemplary detailed organization rating screen, in an embodiment.

FIG. 4 an exemplary pre-license purchase screen, in an embodiment.

FIG. 5 shows an exemplary fund screen, in an embodiment.

FIG. 6 shows an exemplary request application uses auction popup screen, in an embodiment.

FIG. 7 shows an exemplary auction screen, in an embodiment.

FIG. 8 shows an exemplary current active auctions popup screen, in an embodiment.

FIG. 9 shows an exemplary application bid popup screen, in an embodiment.

FIG. 10 shows an exemplary new organization assignment screen, in an embodiment.

FIG. 11 shows an exemplary pre-licensing system, in an embodiment.

FIG. 12 shows an exemplary pre-licensing method, in an embodiment.

### DETAILED DESCRIPTION OF THE FIGURES

### Prerelease Application Licensing

The present system allows any registered user to pre-license an application, that is, to license an application, such as a software application, prior to its release. This provides funds to the application developer to assist in the development of the software application. As an incentive to licensing an application before its release (pre-licensing), each pre-license allows the pre-license holder, or pre-licensee, to occupy an organization position called an observer. Observers can “see” other observers, administrators, and developers that exist within the software/development environment and are associated with the pre-licensed application. This gives the pre-license holder access to, and possibly oversight of, the application creators, thereby decreasing risk to the user, for example, the risk that the application will not be completed. Similar to other positions within the development environment, the observer position may share a percentage of the future income from the pre-licensed application. Licenses are managed by the development environment, such that the development environment may insure or otherwise facilitate the distribution of post-release licensing income with the pre-licensees.

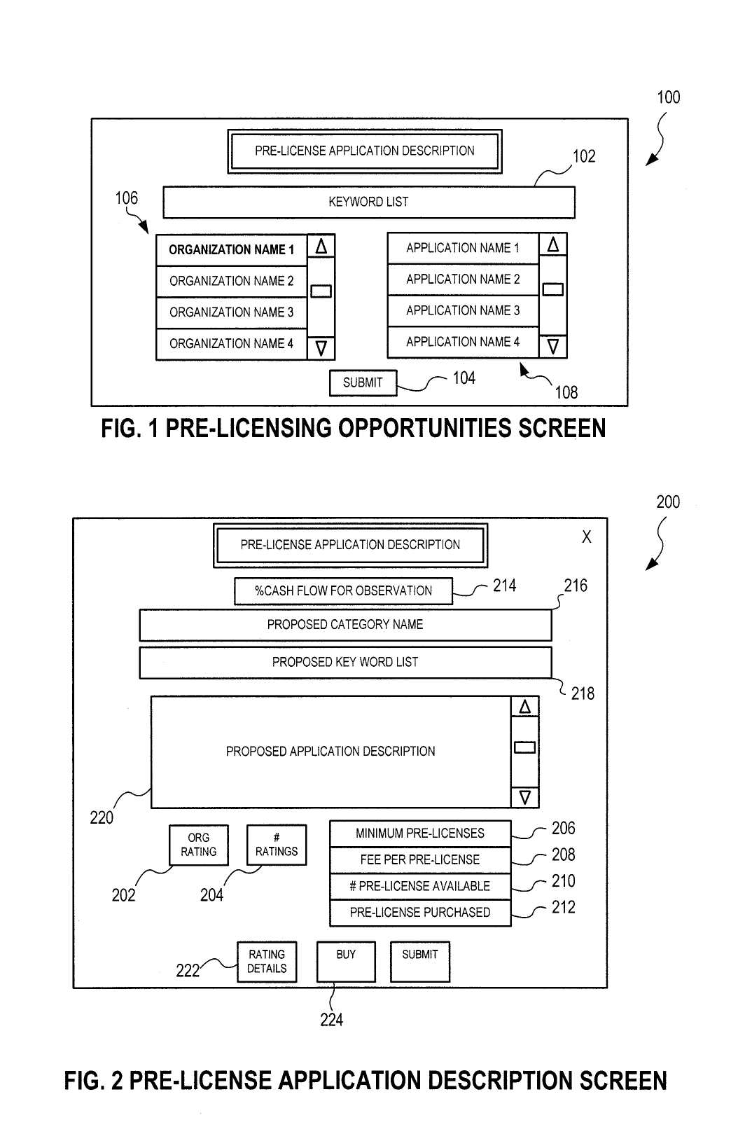

FIG. 1 shows an embodiment of a pre-licensing opportunities screen 100, utilized in a system for prelease application licensing. A keyword list 102 allows the user to enter a keyword description of the type of pre-license opportunity desired. Entering a keyword list followed by selection of the “Submit” button 104 causes a list of Organizations 106, which includes Organization Names, for example, Organization Name 1-4. Also displayed to the user is a list of Application 108, which represents Pre-licenses, shown including Application Name 1-4. By selecting an Organization from the list of Organizations 106 causes the list of Applications 108 to displayed applications associated with the selected Organization. In one embodiment, pre-licensing opportunities screen 100 only displays an Organization's applications that are available for pre-license. Selecting an application name causes the Pre-license Application Description screen to be displayed, see FIG. 2.

FIG. 2 shows one example of a pre-license application description screen 200. This screen may be utilized by user to assist in determine if a pre-license for an application should be purchased, for example, by viewing an organization's statistics, as shown in fields 202-220. The statistic fields shown in the embodiment of FIG. 2 include the organization rating field (Org Rating 202), number of ratings field (# Ratings 204), minimum number of Pre-licenses field (Minimum Pre-Licenses 206), license fee per use field (Fee per Pre-License 208), number of pre-licenses available field (# of Pre-Licenses Available 210), Pre-license purchased (Pre-license purchased 212), percentage of cash-flow given for observation field (% Cash Flow for Observation 214), proposed category name 216, proposed keyword list field 218, and the proposed application description field 220 on Pre-license Application Description screen 200. Other statistics may be displayed without departing from the scope herein.

In one embodiment, Org Rating 202 field contains a number from 1-10 (for example, 1 being the lowest rating and 10 being highest rating) that represents the average rating given to the organization from sources given the opportunity to rate the organization. One source for organization ratings may be provided by individuals that have worked for the organization, directly or indirectly. In one example, at the completion of a work project, the author of that work can enter a score from 1 to 10 for the Organization, which may be processed to affect the Organization Rating shown in Org rate 202. Pre-license holders may also be able to rate an Organization, for example, one time per pre-licensed application in which they hold a pre-license.

The # Ratings field 204 represents the total number of individual ratings submitted for an organization. # Ratings field 204 is used to show the relevancy of the organization rating, for example, the fewer ratings the lower the relevancy.

The Minimum Pre-licenses field 206 shows the minimum number of pre-licenses/uses that are allowed to be purchased.

The Fee per Pre-License field 208 shows the cost per pre-license, also called a “use” herein.

The # Pre-Licenses Available field 210 shows the number of remaining Pre-licenses available.

The % of Cash-Flow for Observation field 214 shows the percentage of the cash-flow obtained from per pre-license after the release of the application. In one embodiment, this may be used to display the progress of the application development on a per-use basis.

The Proposed Keyword List field 218 contains the initial keyword list that may be associated with the proposed application such that the proposed application may be found using a search query/search engine.

The Proposed Application Description 220 is a description of the proposed application.

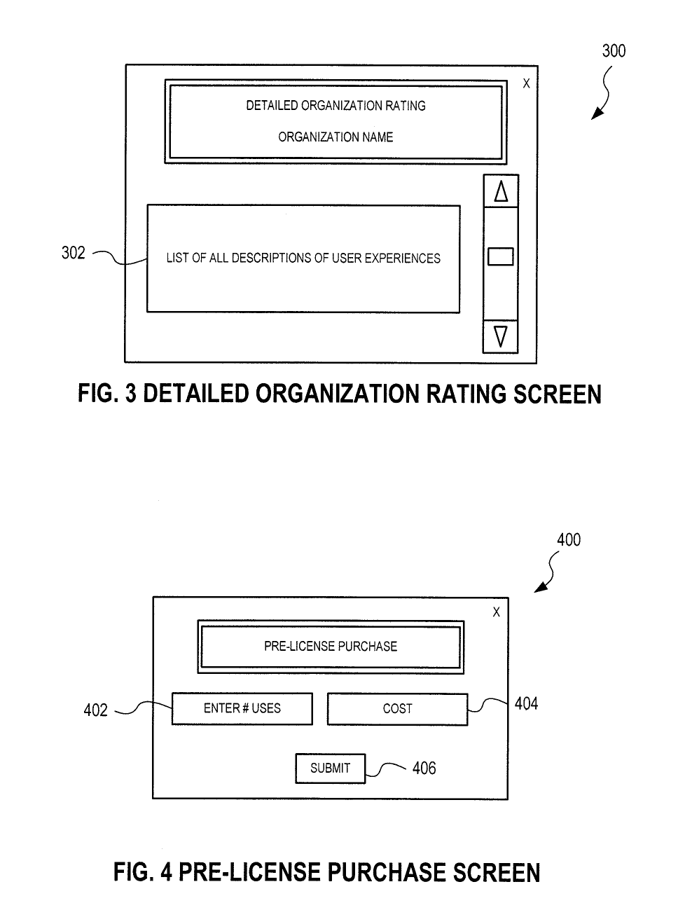

Additional information concerning an application can be obtained by a user by selecting Rating Detail button 222 of FIG. 2. By selection Rating Detail button 222, the Detailed Organization Rating screen 300 (FIG. 3) is displayed.

A Buy button 224 is also provided, such that a user may initiate a purchase of a pre-license. By selecting Buy button 224, a user moves to a pre-license purchase screen 400, FIG. 4.

FIG. 3 shows a Detailed Organization Rating screen 300. By selection Rating Detail button 222 of FIG. 2, the Detailed Organization Rating screen 300 is displayed. Detailed Organization Rating screen 300 shows a list of all descriptions of user experiences 302.

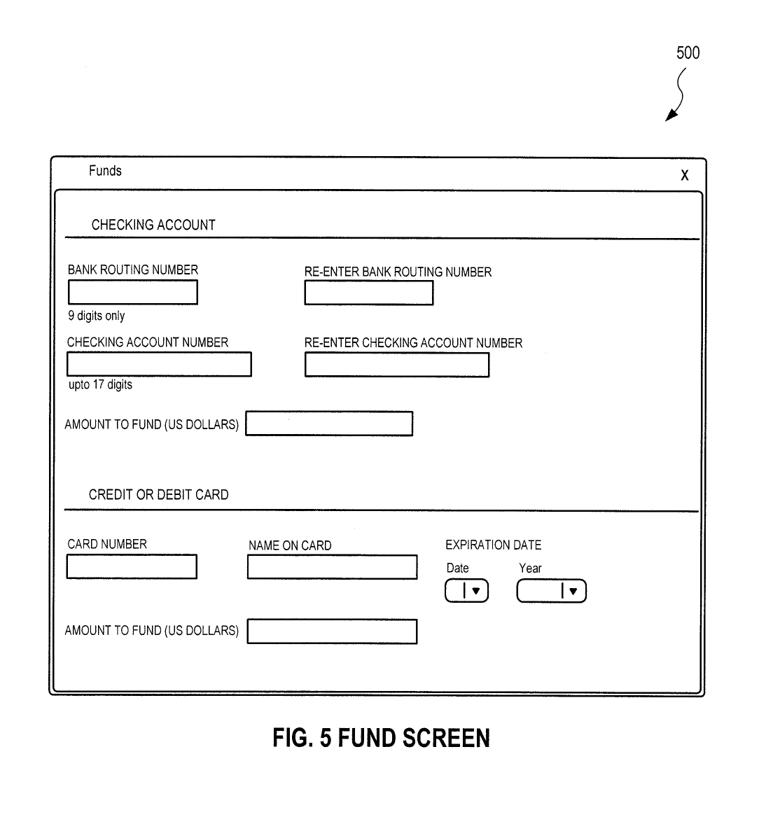

FIG. 4 shows a pre-license purchase screen 400. Selecting Buy 224 button from pre-license application description screen 200 cause the pre-license purchase screen 400 of FIG. 4 to appear. A user may enter the number of uses requested in to the Enter # Uses 402 field. This causes the cost to be computed and displayed in Cost 404 field. Pre-license purchase screen 400 also includes a Submit 406 button. Selecting a Submit 406 button initiates the funds transfer process, see FIG. 5.

FIG. 5 shows a funds screen 500. Selecting Submit 406 button of FIG. 4 causes a Funds Screen 500 of FIG. 5, to appear. This is a standard purchase screen which may, for example, utilize a credit or debit card or a checking account to allow a user to complete the transaction. The present system does not require the use of funds screen 500 for purchasing a pre-license. Other purchasing transactions may be used, for example, an in person transaction, telephonic transaction, or via a third party.

### Limits on Use of Prerelease Uses Funds

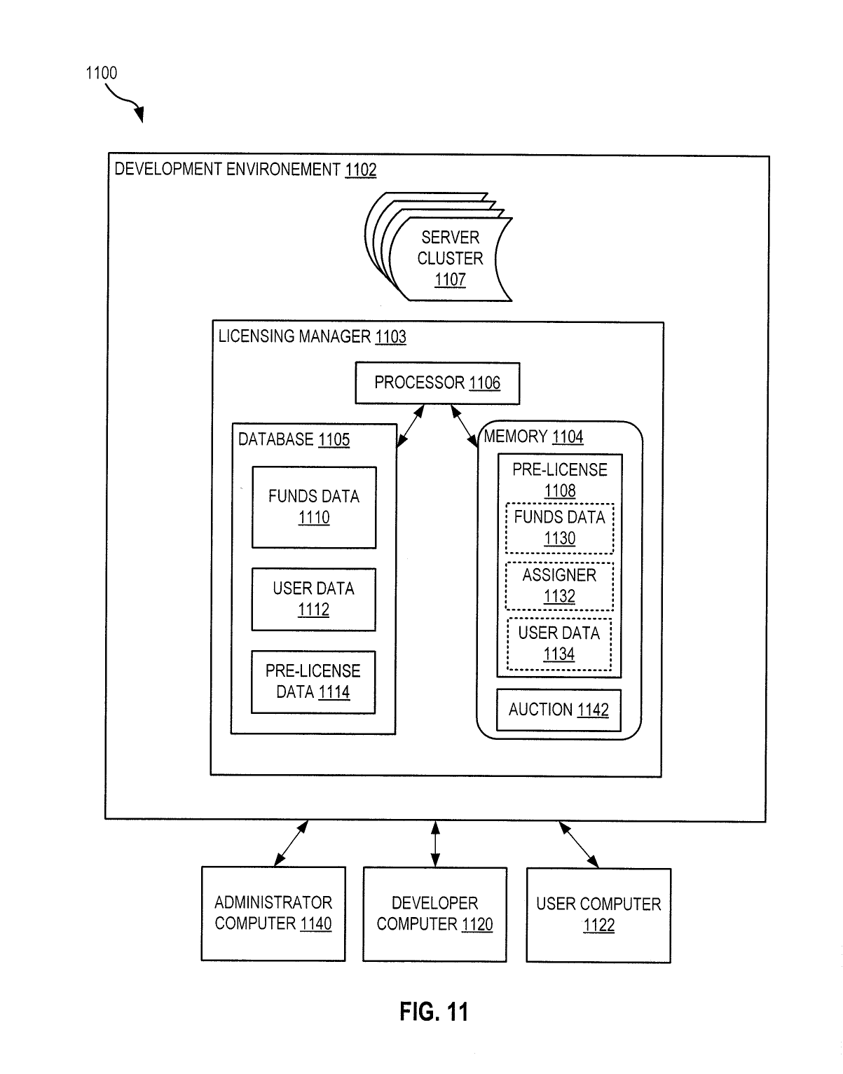

Organizations receiving funds from the sale of pre-licenses or pre-released uses can allocate those funds by selecting an administrator, developer, or both on the Administrator Payment Distribution screen (not shown) for a particular project and inserting, for example, a payment start date, period, and per-period payment amount for that administrator/developer. In one configuration, the pre-release funds are accumulated as per the agreed payment period, but payments are only released after the application has been released. After the application has been released, the accumulated funds shall be automatically transmitted to all administrators and developers as agreed upon by those administrators, developers, and the organization. It should be understood that a “developer” maybe be separate organization. In an alternative configuration pre-lease funds are paid in full, but the payment is released when pre-specified milestone area reached. Other funding/payment configurations may be utilized without part from the scope herein. In an embodiment, the funds associated with the sale of pre-licenses are distributed to the organization automatically be the development environment, for example, by licensing manager 1103, FIG. 11.

### Auctioning Application Uses

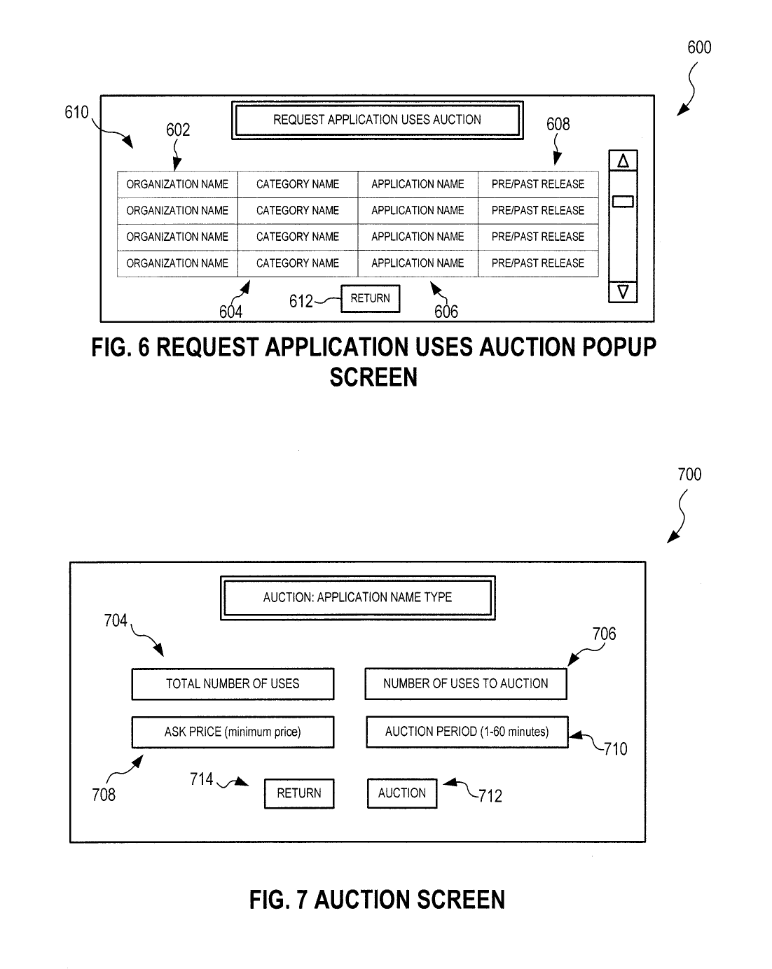

FIG. 6 shows a Request Applications Uses Auction screen 600 utilized by a user that has purchased more application uses than he/she needs. Screen 600 gives a user access to functionality for auctioning off their excess application uses to other users. By initiating functionality for auctioning application uses, the system is caused to display the Request Application Uses Auction 600, FIG. 6.

The Request Application Uses Auction screen 600 shows a list of applications 610 owned by the user formed, for example, in columns and rows. Each row contains the application's owning organization 602, category 604, application name 606 and the pre/post-release 608 indicator. The pre/post-release 608 indicator shows that the associated application uses are pre-release or post-release uses. Selecting a particular row from the list of applications 610, for example, by highlighting a row and selecting a return 612 button, will cause the system to display an auction screen (see FIG. 7) for the selected row.

FIG. 7 shows an auction screen 700 utilized by a user to auction application uses. In order to set up an auction, the user utilizes auction screen 700 to fill in a number of uses to auction 706, an ask price 708, and an auction period 710. After filing in boxes 706-710, the user may select, by “clicking”, an auction button 712. In an embodiment, it is possible for an owner/administrator of the development environment to development revenue as a percentage of every transaction and not on spread between the bid and ask prices. Ask price 708 only represents the user's minimum acceptable price. The number of uses to auction 706 shows a number that represents the total number of uses that the user is willing to sell, and the auction period 710 is the amount of time the system will wait before declaring a winner or informs all bidders the minimum price has not been met. A return button 714 is provided on screen 700 to return the user to the previous screen.

### Application Use Bids

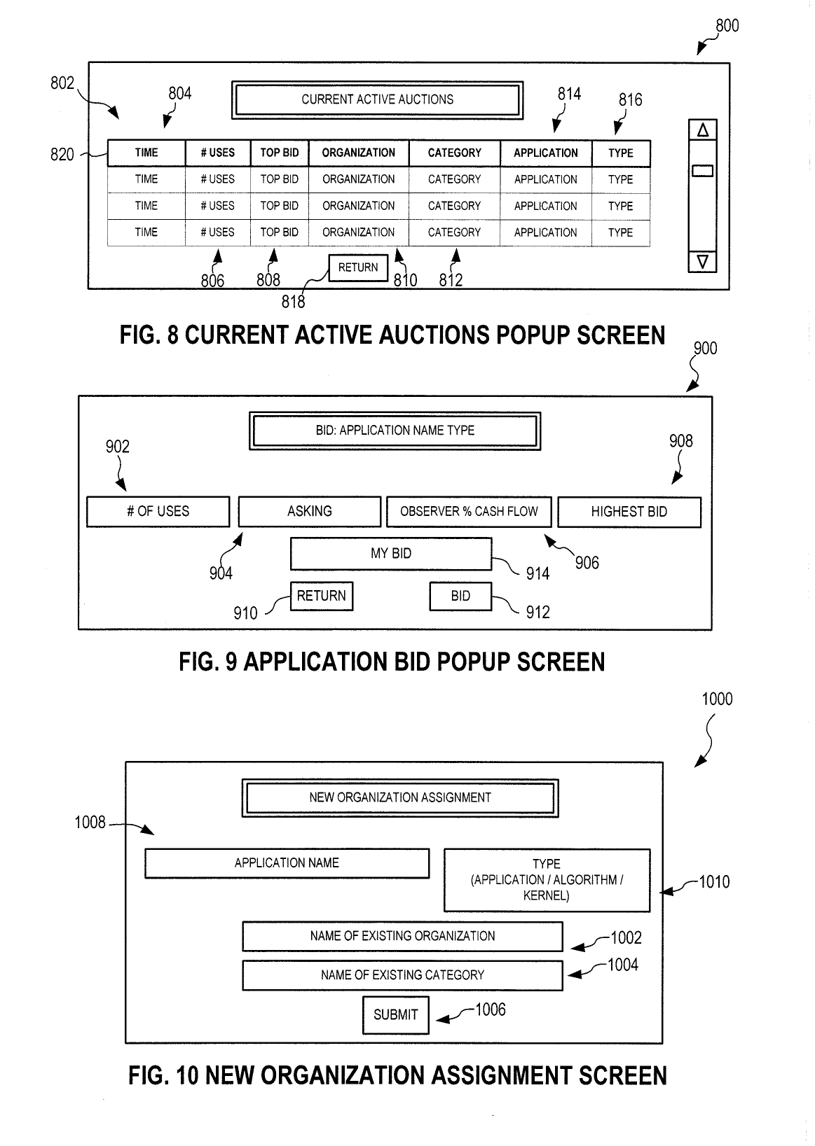

FIG. 8 shows a current active auction screen 800. A list of current auctions 802 is shown organized as a series of rows and columns. Each row details one or more auctioned uses of an application. Columns of list 802 show time remaining 804, a number of uses up for auction 806, top bid 808, organization 810, category 812, application name 814, and application type 816. Selecting a row from list of current auctions 802 on current active auctions screen 800 may cause the description of the application to be displayed. Selecting a row followed by “clicking” a return 818 button initiates the next step in a bidding process, for example, causing an application bid screen to appear.

FIG. 9 shows an embodiment of an Application Bid screen 900 for bidding on an application use selected in FIG. 8. In FIG. 8, a user selects an application they would like to bid on and then “clicks” return 818 button, which causes Application Bid screen 900 to appear. Application Bid screen 900 includes a number of uses 902, an asking price 904, an observer percentage of cash flow 906, a highest bid 908, and a “my bid” 914. The user may alter the quantity of uses within the number of uses 902 to reflect the number of uses the user would like to bid on and enter a bid amount in “my bid” 914. Selecting bid 912 initiates the next step in the bidding process. Selecting return 910 returns to previous screen.

Upon receipt of a bid from screen 900, for example, via a bid message (not shown), the present system determines if the bid is higher than a current highest bid and determines if the bidding end time has not be met. If both conditions are met, the system will add the bid information to the end-user's auction table.

FIG. 10 shows assignment screen 1000 for re-assigning an application to a new organization, for example, after it is determined that a user is a highest bidder. Screen 1000 includes an application name 1008, an application type 1010, a name of the existing organization 1002, a name of existing category 1004, and a submit button 1006. The name of a preexisting organization is entered into name of existing organization 1002 box. The name of an existing category is then entered into name of existing category 1004 box. The user then select the submit button 1006, which causes the present system to generate and transmit an Application Organization Reassignment message (not shown) to the development environment for processing.

FIG. 11 shows a pre-licensing system 1100 for pre-licensing an application prior to its completion. In the present embodiment, pre-licensing system 1100 includes a development environment 1102, an administrator computer 1140, a developer computer 1120, and a user computer 1122. System 1100 may include more or fewer components without departing from the scope herein. User computer 1122 provides a user (not shown) access to development environment 1102 to, for example, search for and select a pre-license opportunity.

Development environment 1102 performs a plurality of functions, some of which include providing a platform or resources for the development of applications, providing pre-licensing functionality, etc. System 1100 of FIG. 11 focuses on pre-licensing functionality.

Development environment 1102 is shown with a server cluster 1107 and licensing manager 1103. Licensing manager 1003 further includes a processor 1106, a database 1105, and a memory 1104. Database 1105 supports a funds data 1110, a user data 1112, and a pre-license data 1114. Memory 1104 supports an auction 1142 functionality and a pre-license 1108 functionality, both of which are executed by processor 1106. In an embodiment, pre-license 1108 accepts funds data 1110 and user data 1112 and convert then funds data 1130, and user data 1134, respectively. Pre-license 1108 also supports an assigner 1132 for assigning pre-licensing rights to users, for example, a user of user computer 1122. Funds data 1130 and user data 1134 may be manipulated by processor 1106 when executing pre-license 1108 functionality. Thereafter, manipulated funds data 1130 and user data 1134 may be saved to funds data 1110 and user data 1112, respectively.

In one example, processor 1106 saves user data 1112 associated with a specific user (not shown) into user data 1134 and a portion of funds data 1110 associated with that user into funds data 1130. Processor 1106 then executes pre-license 1108, determining that the user has selected a pre-license opportunity (not shown) and that funds have been transferred. Processor 1106 updates funds 1130, and executes assigner 1132 to assign a pre-license to the user by updating user data 1134. Processor 1106 then saves funds data 1130 and user data 1142 in the appropriate locations within funds data 110 and user data 1112.

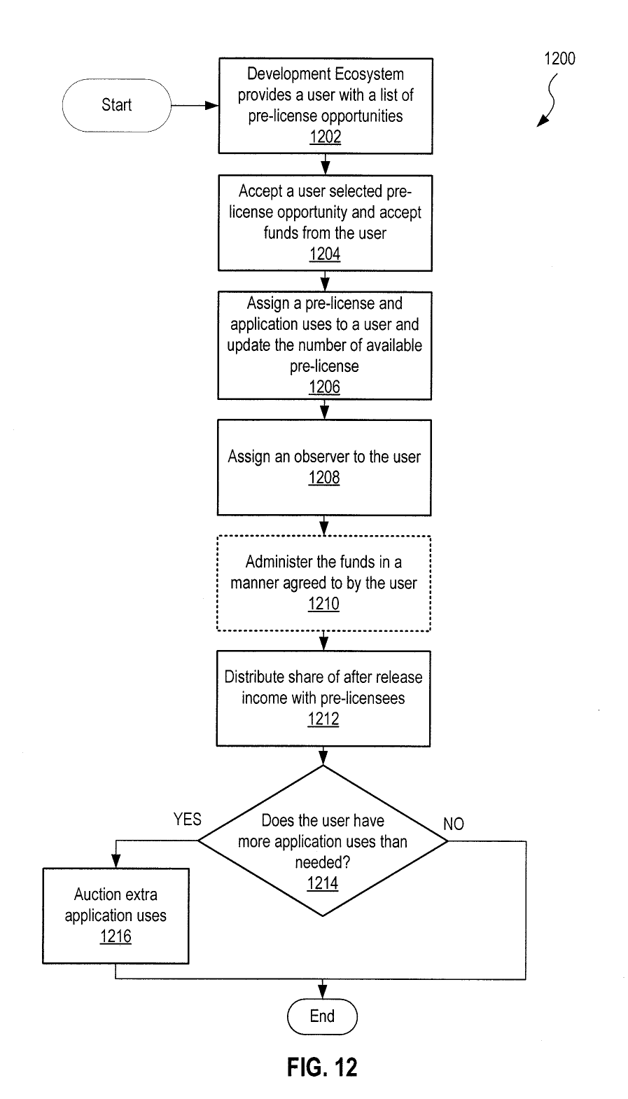

FIG. 12 shows one exemplary method 1200 for assigning a pre-license to a user. Method 1200 should be viewed in combination with system 1100 of FIG. 11.

In step 1202 of method 1200 a user accesses a development environment in search of pre-license opportunities. In one example of step 1202, a user (not show) accesses development environment 1102 via user computer 1122. Development environment sends at least a portion of pre-license data 1114, for example as a list of pre-license opportunities filtered by a user selected criteria, to user computer 1122.

In step 1204, method 1200 accepts a user selected pre-license opportunity and funds from the user to secure the pre-license opportunity. In one example of step 1204, licensing manager 1103 accepts a user selected pre-license opportunity and executes funds data 1130 of pre-license 1108 to update funds data 1110 associated with the user.

In step 1206 method 1200 assigns a pre-license and application uses to the user and updates the number of available pre-licenses associated with the application. In one example of step 1206, processor 1106 saves user data 1112 in user data 1134 of memory 1108. Processor 1106 then executes assigner 1132 of pre-license 1108 to assign a pre-license and a number of uses of the application associated with the pre-licensed to the user saved in user data 1134. Assigner 1132 then updates the number of available pre-licenses in pre-license data 1114.

In step 1208 an observer is assigned to the user. In one example of step 1208 assigner 1132 assigns a user to a user by updating user data 1134. In optional step 1210, method 1200 administers the funds in a manner agreed to by the user. Administering funds may be, for example, allocating a portion of the funds when project miles in the development of the application are met. Any number of fund administering may be available to step 1210. In one example of step 1210, licensing manager 1103 distributes a portion of funds stored in funds data 1110 which are associated with the user and the application that has been pre-licensed. Licensing manager 1103 distributes the portion of funds to the developers of the application which has been pre-licensed in a manner agreed to by the user. Step 1210 moves to step 1212.

In step 1212 method 1200 distributes a share of income associated with the completed application which the user has pre-licensed. In one example of step 1212, license manager 1103 distributes a share of income associated with the pre-license assigned to the user, for example, by license manager 1103 updating a financial aspect (not shown) of user data 1112 associated with the user's pre-license.

Step 1214 is a decision step. In decision step 1214 method 1200 determines if the user has more application uses associated with the pre-license then the user needs. If the user does not have more application uses than the user needs, method 1200 ends. If the user does have more applications uses, step 1216 is then executed. In one example of decision step 1214, licensing manager 1103 sends a request to auction application uses to user computer 1122.

In step 1216, method 1200 provides a platform for the user to auction off extra application uses. In one example of step 1216, processor 1106 executes auction 1142 functionality providing a platform for auctioning application uses. Method 1200 then ends.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A computer implemented method for pre-licensing an application within a development environment to provide funds to a developer of the application, comprising the steps of:
accepting funds from a user within the development environment;
assigning a pre-license to the user; and
automatically administering the funds to the developer in a manner controlled by the development environment.

2. The method of claim 1, wherein the step of assigning a pre-license comprises assigning, to the user, an observer associated with the assigned pre-license, the observer providing, to the user, information associated with the application, and a share of the future income from the pre-licensed application.

3. The method of claim 2, wherein the observer provides access to developer of the application.

4. The method of claim 2, wherein the observer provided information relates to other observers, administrators, and developers associated with the application.

5. The method of claim 1, further including the step of automatically administering the funds to an administrator associated with the pre-license in a manner controlled by the development environment.

6. The method of claim 1, further including the step of distributing a portion of after release income with the user.

7. The method of claim 6, wherein the step of distributing a portion of after release income with the user comprises the development environment automatically distributing the after release income.

8. The method of claim 7, wherein the step of distributing a portion of after release income comprises updating a financial aspect of user data that is associated with the user's pre-license within the development environment.

9. The method of claim 1, wherein administering the funds includes assigning a payment start date, a payment period, and per-period payment amount.

10. The method of claim 1, wherein the step of administering the funds is in a manner agreed to by the user.

11. The method of claim 10, wherein the step of administering the funds is in a manner agreed to by the user comprises allocating funds by selecting one or more of a payment start date, one or more payment periods, a per-period payment amount, and payment milestones.

12. The method of claim 10, wherein funds are only released after the application has been released.

13. The method of claim 1, further comprising the step of auctioning off a user's excess uses of the pre-license.

14. A system for pre-licensing an application within a development environment to provide funds to a developer of the application, comprising:
a licensing manager situated within the development environment, comprising:
a database for storing pre-license data associated with the one or more applications to be pre-licensed, user data associated with one or more users pre-licensing the one or more applications, and funds data associated with one or more users pre-licensing the one or more applications,
a memory for storing a pre-license executable code, which includes an assigner for assigning one or more applications to be pre-licensed to a user by updating the user data with the pre-license data, and a funds transfer code for accepting funds from the user, updating the funds data and automatically transferring the funds to the developer, and
a processor, which executes the pre-license executable code.

15. The system of claim 14, wherein the assigner includes capability for assigning an observer position to the user.

16. The system of claim 14, wherein the licensing manager distributes the pre-license funds to the developer based on milestones achieved by the developer in the development of the pre-licensed application.

17. The system of claim 15, wherein the licensing manager distributes the pre-license funds to the developer based on a payment start date, a payment period, and per-period payment amount.

18. The system of claim 14, wherein the licensing manager automatically distributes a portion of post release income associated with the pre-license assigned to the user.

19. The system of claim 14, further comprising an auction module for auctioning off a user's excess application to one or more other users.

20. The system of claim 19, wherein the assigner includes capability for reassigning the user's pre-license to the one or more other users after the one or more other users win an auction for the pre-license.
